(19) United States
(12) Patent Application Publication
(10) Pub. No.: US 2025/0013814 A1
(43) Pub. Date: Jan. 9, 2025

(54) ESTIMATION METHOD USED IN INTEGRATED CIRCUIT CHIP OF INTEGRATED CIRCUIT DESIGN AND INTEGRATED CIRCUIT CHIP

(71) Applicant: Realtek Semiconductor Corp., HsinChu (TW)

(72) Inventors: Wei-Ming Huang, HsinChu (TW); Mei-Li Yu, HsinChu (TW); Yu-Lan Lo, HsinChu (TW)

(73) Assignee: Realtek Semiconductor Corp., HsinChu (TW)

(21) Appl. No.: 18/668,230

(22) Filed: May 19, 2024

(30) Foreign Application Priority Data
Jul. 5, 2023 (TW) 112125112

(51) Int. Cl. G06F 30/392

(52) U.S. Cl. CPC G06F 30/392

(57) ABSTRACT

A method of an integrated circuit chip, includes: calculating a first slope of distance-to-spatial relation under first design condition according to spatial distance difference between two circuit elements within integrated circuit chip and a spatial process variation under first design condition; calculating a second slope of the distance-to-spatial relation under a second design condition according to the spatial distance difference and a spatial process variation under second design condition; calculating a ratio coefficient and an exponential coefficient according to the first slope, the second slope, a global process variation under the first design condition, and a global process variation under the second design condition; calculating a third slope of the distance-to-spatial relation under a third design condition according to the ratio coefficient and the exponential coefficient; and estimating a spatial process variation under the third design condition according to the third slope and the spatial distance difference.

### BACKGROUND OF THE INVENTION

### 1. Field of the Invention

The invention relates to an integrated circuit design, and more particularly to an integrated circuit chip and an estimation method of the integrated circuit chip used in an integrated circuit design.

### 2. Description of the Prior Art

Generally speaking, a traditional integrated circuit design needs to use combinations of various kinds of different design conditions such as different standard cell heights, different voltages, different channel lengths, and different operation temperatures so as to generate or form a spatial variation model of the traditional circuit integrated design. There are two conventional methods for generating the data of the spatial variation model. A first conventional method is to directly obtain the data of the spatial variation model from the chip has been manufactured, and the directly obtained chip data will be very accurate but it needs to consume a very long flow time and a very high cost to implement this first conventional method. For example, the first conventional method actually needs to design and manufacture a test circuit chip, to make the fabrication factory to manufacture chips under different design conditions, and then to measure the data of the manufactured chips. This significantly consumes resources for the circuit designer. The second conventional method is to directly refer to a neighboring and similar design condition such as a similar design condition which has been recorded in the spatial variation model. However, the design conditions will significantly change in response to different design requirements such as different voltages, different standard cell heights, different channel lengths and/or different operation temperatures, and so on. Thus, for the second conventional method for directly referring to the similar design condition to generate the data of the spatial variation model, even though it is not needed to measure the chip's data, however, the accuracy of the generated data of the spatial variation model will be not enough and worse.

### SUMMARY OF THE INVENTION

Therefore one of the objectives of the invention is to provide an integrated circuit design and a corresponding method to solve the above problems.

The invention uses a mathematical regression analysis method to perform interpolation or extrapolation based on the existing data of the spatial variation model so as to achieve a higher data accuracy as well as rapidly generating the data of the spatial variation model, to solve the problems. Compared to the conventional methods, the cost is relatively smaller.

According to the embodiments, an estimation method of an integrated circuit chip used in an integrated circuit design is disclosed. The estimation method comprises: obtaining a global process variation under a first design condition and a spatial process variation under the first design condition; obtaining a global process variation under a second design condition and a spatial process variation under the second design condition; calculating a first slope value of a distance-to-spatial relation under the first design condition according to a spatial distance value between a first circuit unit of the integrated circuit chip and a second circuit unit of the integrated circuit chip and the spatial process variation under the first design condition, both the first circuit unit and the second circuit unit having a specific circuit design structure; calculating a second slope value of a distance-to-spatial relation under the second design condition according to the spatial distance value and the spatial process variation under the second design condition; calculating a linear regression coefficient and a polynomial regression coefficient according to the first slope value, the second slope value, the global process variation under the first design condition, and the global process variation under the second design condition; simulating to calculate a global process variation under a third design condition; calculating a third slope value of a distance-to-spatial relation under the third design condition according to the linear regression coefficient, the polynomial regression coefficient, and the global process variation under the third design condition; and estimating a spatial process variation of the third deign condition for the spatial distance value between the first circuit unit and the second circuit unit according to the third slope value and the spatial distance value.

According to the embodiments, an integrated circuit chip is disclosed. The integrated circuit chip comprises a first circuit unit and a second circuit unit. Both the first circuit unit and the second circuit unit have a specific circuit design structure. A spatial distance value between the first circuit unit and the second circuit unit of the integrated circuit chip and a spatial process variation of a first design condition of the integrated circuit chip are used to calculate a first slope value of a distance-to-spatial relation under the first design condition. The spatial distance value and a spatial process variation of a second design condition of the integrated circuit chip are used to calculate a second slope value of a distance-to-spatial relation under the second design condition. The first slope value, the second slope value, a global process variation under the first design condition of the integrated circuit chip, and a global process variation under the second design condition of the integrated circuit chip are used to calculate a linear regression coefficient polynomial regression coefficient. The linear regression coefficient, the polynomial regression coefficient, and a global process variation of a third design condition of the integrated circuit chip are used to calculate a third slope value of a distance-to-spatial relation under the third design condition. The third slope value and the spatial distance value are used to calculate a spatial process variation under the third design condition of the integrated circuit chip under the spatial distance value between the first circuit unit and the second circuit unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a flowchart of a method for estimating a spatial process variation of an integrated circuit chip used in an integrated circuit design according to an embodiment of the invention.

FIG. 2 is a diagram of an example of the global process variation, local process variation, and spatial process variation according to an embodiment of the invention.

FIG. 3 is a diagram of an example of the regression calculation of the flowchart method in FIG. 1 according to an embodiment of the invention.

### DETAILED DESCRIPTION

The invention aims at providing a method capable of rapidly and enough accurately generating and estimating a spatial process variation of a circuit unit of an integrated circuit chip under a specific design condition. The method can refer to spatial process variation(s) of circuit unit(s) of the integrated circuit chip and use regression analysis calculation to accurately estimating the spatial process variation(s) of the circuit unit(s) of the integrated circuit chip under the specific design condition, without needing to actually measuring the spatial process variation of the integrated circuit chip under the specific design condition. Therefore, the method can significantly reduce the manufacturing time and measuring time of the fabrication factory to significantly reduce process costs.

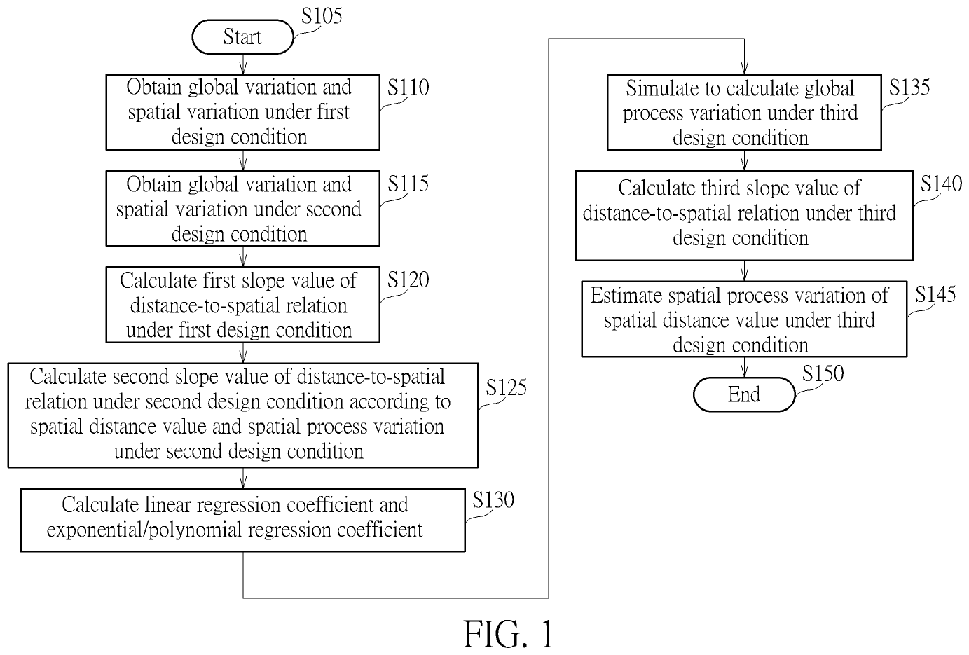

Refer to FIG. 1. FIG. 1 is a diagram of a flowchart of a method for estimating a spatial process variation of an integrated circuit chip used in an integrated circuit design according to an embodiment of the invention. If substantial the same result can be achieved, the steps are not limited to be performed following the order shown in FIG. 1, and the other steps may be inserted into intermediate steps. The steps of the flowchart of the method of the invention are described in the following:
Step S105: Start;
Step S110: Obtain a global process variation (or inter-die process variation) of an integrated circuit chip/die under a first design condition and a spatial process variation under the first design condition;
Step S115: Obtain a global process variation and a spatial process variation of the integrated circuit chip under a second design condition;
Step S120: Calculate a first slope value of a distance-to-spatial relation under the first design condition according to a spatial distance value between a first circuit unit of the integrated circuit chip and a second circuit unit of the integrated circuit chip and the spatial process variation under the first design condition, wherein both the first circuit unit and the second circuit unit have a specific circuit design structure such as a specific transistor structure, e.g. an inverter (but not limited);
Step S125: Calculate a second slope value of an distance-to-spatial relation under the second design condition according to the spatial distance value and the spatial process variation under the second design condition;
Step S130: Calculate a linear regression coefficient and an exponential/polynomial regression coefficient according to the first slope value, the second slope value, the global process variation under the first design condition, and the global process variation under the second design condition;
Step S135: Simulate to calculate a global process variation under a third design condition;
Step S140: Calculate a third slope value of a distance-to-spatial relation under the third design condition according to the linear regression coefficient, the polynomial regression coefficient, the global process variation under the third design condition;
Step S145: Estimate a spatial process variation of the spatial distance value between the first circuit unit and the second circuit unit under the third design condition according to the third slope value and the spatial distance value; and
Step S150: End.

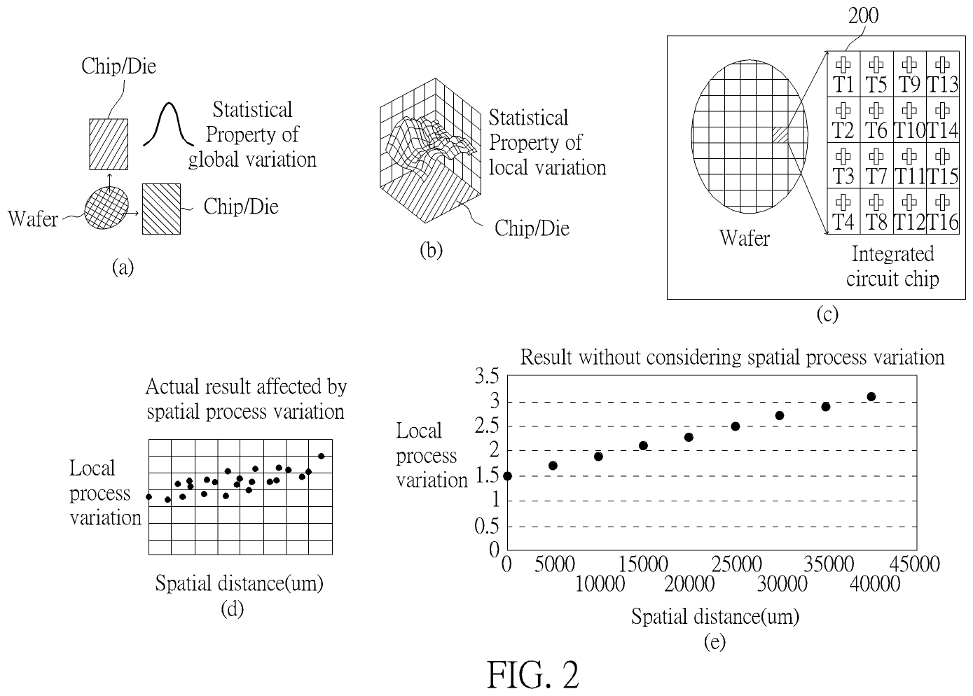

In the following paragraphs, the differences of the definitions of global process variation, local process variation (or intra-die process variation, and spatial process variation are described. Refer to FIG. 2. FIG. 2 is a diagram of an example of the global process variation, local process variation, and spatial process variation according to an embodiment of the invention. The yield rate of chip manufacturing circuit design for example depends upon the factors such as the global process variation, local process variation, and spatial process variation, and thus it is needed to consider the three different variations for the circuit chip design.

The first variation is the global process variation and indicates inter-die, chip-to-chip, lot-to-lot, or wafer-to-wafer variations for the same circuit design units. For example, the global process variation may be caused due to the non-uniform semiconductor fabrication process for chips, e.g. non-uniform etching, exposure, or chemical deposition of the semiconductor fabrication process. When analyzing the global process variation, it is needed to consider the actual operation voltage, operation temperature, and selected threshold voltage of the semiconductor fabrication process. For example, as shown in the portion (a) of FIG. 2, one wafer among multiple wafers may comprise multiple chis/dies, and the statistical property of the global process variation shows a type of the Gaussian distribution (but not limited).

In addition, the second variation is the local process variation and indicates intra-die variation inside one chip for the same circuit design unit. The local process variation is a variation randomly occurring inside a small size chip for the uniform semiconductor fabrication process for chips. For example, as shown in the portion (b) of FIG. 2, the statistical property of the local process variation occurring inside one chip/die shows a type of distribution similar to a randomly generated distribution (but not limited).

Further, the third variation is the spatial process variation which is a variation caused due to the different distances between different spatial positions disposed inside the same chip based on the same circuit design unit. For example, two circuit units having the same design inside the same chip may introduce the spatial process variation due to their distance may become different inside the same chip. The value of spatial process variation may become different due to different design conditions such as different standard cell heights, different voltages, different channel lengths, or different operation temperatures.

The value of spatial process variation will be proportional to the distance value. For example, as shown in the portion (c) of FIG. 2, one wafer comprises multiple chips/dies, and one chip/die comprises multiple circuit units such as transistors T1-T16 (but not limited). A first circuit unit such as transistor T1 in the transistors T1-T16 and a second circuit unit such as transistor T16 or the other transistors for example have the same circuit design structure such as an inverter (but not limited) and/or for example operate under the same design condition. As shown in the portion (d) of FIG. 2, it shows the resultant values of local process variation affected by furthering considering the spatial process variation, wherein the horizontal axis indicates i the different spatial distances (the unit is μm) of circuit units disposed in one chip and the vertical axis indicates the corresponding values of local process variation which is actually measured. When the spatial distance is zero, the value is a pure local process variation and is not affected by the spatial process variation. However, when the spatial distance is not zero, measuring the value of local process variation needs further considering the influence of the spatial process variation. The values of the actually measured local process variation for the transistors T1-T16 are different due to that their arranged spatial locations' distances are different.

In addition, as shown in FIG. 2, the statistical property of the spatial process variation for the circuit units inside the same chip shows one statistical trend similar to an increase linear growth. Refer to the portion (e) of FIG. 2 again, which shows that the resultant values of the local process variation without considering the influence of the spatial process variation. The horizontal axis indicates the different spatial distances (the unit is μm) of circuit units disposed inside one chip and the vertical axis indicates the corresponding values of local process variation which is actually measured. If the spatial process variation is not considered, then the resultant values for example may be shown in the following table:

| | Resultant values | spatial process | Resultant values |
|---|---|---|---|
| | by only | variation value | with further |
| spatial | considering local | (generated from | considering spatial |
| distance | process variation | equation) | process variation |
| 0 | 1.5 | | |
| 5000 | 1.7 | “=1.7/1.5” | 1.13 |
| 10000 | 1.9 | “=1.9/1.5” | 1.27 |
| 15000 | 2.1 | “=2.1/1.5” | 1.40 |
| 20000 | 2.3 | “=2.3/1.5” | 1.53 |
| 25000 | 2.5 | “=2.5/1.5” | 1.67 |
| 30000 | 2.7 | “=2.7/1.5” | 1.80 |
| 35000 | 2.9 | “=2.9/1.5” | 1.93 |
| 40000 | 3.1 | “=3.1/1.5” | 2.07 |

As mentioned in the previous paragraphs, a conventional integrated circuit design needs to use multiple kinds of design conditions, e.g. multiple combinations of design conditions such as different standard cell heights, different voltages, different channel lengths, and different operation temperatures, to generate or form a spatial variation model of the integrated circuit design. The spatial variation for example comprises the routing design of a clock tree synthesis, e.g. a lookup table. The lookup table may comprise various kinds of different distance values and corresponding various kinds of percentage derate values of the routing timing which are actually measured under different design conditions for the conventional integrated circuit design. For example, based on the different distance values, it is needed to multiply the cell delay of the designed circuit unit/element with corresponding different percentage derate values to reflect, compensate, and reduce the influence caused by the spatial process variation.

The advantage is that the method provided by the invention can generate the value (having enough accuracy) of a spatial process variation corresponding to another design condition by using rapid regression analysis calculation so as to generate or form a spatial variation model if the values of the spatial process variation corresponding to at least two sets of design conditions have been measured, without needing to perform the measuring operation for each of the all different design conditions compared to the conventional method.

For example (but not limited), to obtain the value of spatial process variation corresponding to design condition of a low voltage such as 0.7 Volts but the actually measured spatial variation model merely comprises the data of the values of spatial process variation corresponding to two different design conditions such as 0.8 Volts and 0.9 Volts, in this situation, the regression analysis method of the invention can rapidly calculate to obtain the value of spatial process variation corresponding to the design condition of 0.7 Volts so as to update the data of the spatial variation model.

The definitions of symbols used in the embodiments of the invention is described in the following:
dᵢⱼ is the distance between the i-th circuit unit/element and the j-th circuit unit/element inside the same chip, and it can be also abbreviated as d;
x indicates a kind of (or a specific) design condition, e.g. x1, x2, and x3 may respectively indicate three different design conditions corresponding to different operation voltages;
σₛ(x)² is the value of spatial process variation under the design condition x and can be also represented by σₛ²(x);
σ_{g}(x)² is the value of global process variation under the design condition x and can be also represented by σ_{g}²(x);
ρ(d) is the function of the relation of the spatial process variation to the distance and is used to indicate the value of spatial process variation generated in response to the distance d when the distance d has been determined; and
Cov(i, j) is the covariance between the i-th circuit unit and the j-th circuit unit.

If the size of the chip is very small, then the local process variation ρ1 is equivalently equal to zero, and the spatial process variation ρ2 is larger than zero and is equal to ρ(dᵢⱼ). The value of global process variation ρ3 is an extreme value and can be equivalent to a fixed value compared to the local process variation ρ1 and spatial process variation ρ2. Cov(i,j) can be indicated by the following equation:

$$Cov ( i , j ) = {{σ}_{g}}^{2} ( x ) + ρ ( d ) \times {{σ}_{s}}^{2} ( x )$$

wherein σ_{g}²(x) is the value of global process variation under the design condition x and can be regarded as a fixed value when the distance d is extremely large under the design condition x. σₛ²(x)=ss(x)×d, wherein ss(x) is a slope value of the spatial process variation σₛ²(x) compared to the distance d under the design condition x. That is, in the embodiments of the invention, the relation of spatial process variation σₛ²(x) to the distance d is to employ the linear regression calculation. In the embodiments, in practice, the slope value ss(x) can be approximated by using a linear regression coefficient a1 to perform a linear regression approximation and using a polynomial regression coefficient b1 to perform an exponential regression approximation so as to approximate the slope value ss(x) as far as possible:

$$ss ( x ) ≅ a 1 \times {( {{σ}_{g}}^{2} ( x ) )}^{b 1}$$

That is, in the embodiments, the relation of the slope value ss(x) of spatial process variation σₛ²(x) and the global process variation σ_{g}²(x) is calculated by using a polynomial regression equation. The invention aims at using values of spatial process variation actually measured under at least two different design conditions such as two different design conditions x1 and x2 to calculate two corresponding slope values ss(x1) and ss(x2) actually measured under two different design conditions x1 and x2, using the above-mentioned linear regression approximation and exponential regression approximate to calculate the values of a1 and b1, using the values of a1 and b1 and the above mentioned approximation equation to calculate and obtain a slope value ss(x3) of the relation of distance d to spatial process variation σₛ²(x3) under the design condition x3, and then calculating and estimating to obtain the value of spatial process variation σₛ²(x3) of the distance d under the design condition x3, so as to add or update the information of the lookup table of the spatial variation model, so that the estimated value/amount of spatial process variation corresponding to the distance d under the design condition x3 can be stored and recorded in the lookup table of the spatial variation model without actually measuring value/amount of spatial process variation under the design condition x3. In addition, a percentage derate value proportional to the estimated value/amount of spatial process variation can be also correspondingly stored and recorded in the lookup table of the spatial variation model. This can make a circuit designer directly select or use the estimated value/amount of spatial process variation to compensate the actual spatial process variation corresponding to the distance d under the design condition x3.

It should be noted that, the method flowchart mentioned above and the calculation of linear regression and exponential regression can be executed/performed by a computer device operated by a circuit chip designer. For example, a processor of the computer device may receive the data of a basic spatial variation model from a fabrication factory, and the basic spatial variation model may comprise the measurement data of the corresponding spatial process variation under two different design conditions x1 and x2 and may exclude the measurement data of spatial process variation under a design condition x3. In this situation, the circuit chip designer can operate the computer device to make the processor execute the above method flowchart and the calculation of linear regression and exponential regression to estimate the value of spatial process variation under the design condition x3 to enhance or update the data of spatial process variation corresponding to the design condition x3 in the basic spatial variation model to generate an updated spatial variation model without needing the measurement operation of the fabrication factory.

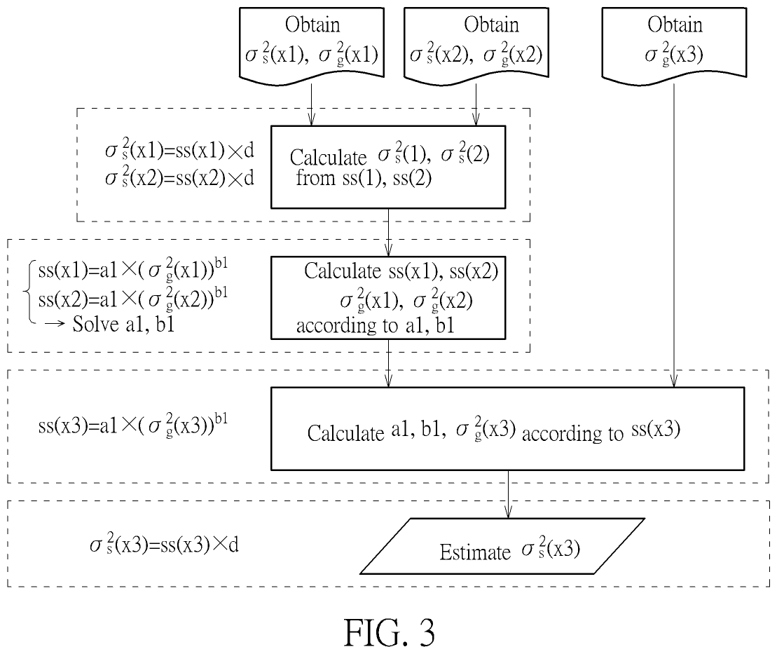

Refer to FIG. 1 again and in conjunction with FIG. 3. FIG. 3 is a diagram of an example of the regression calculation of the flowchart method in FIG. 1 according to an embodiment of the invention. As shown in FIG. 3, at first, the circuit designer for example may use a computer device to receive and obtain the actually measured spatial process variation σₛ²(x1) corresponding to a first design condition x1 such as a first operation voltage from a fabrication factory and also use the computer device to analyze and compute the global process variation σ_{g}²(x1) under the first design condition x1 from the model data provided by the fabrication factory, as shown in Step S110. Then, in Step S115, similarly, the circuit designer for example may use the computer device to receive and obtain the actually measured spatial process variation σₛ²(x2) corresponding to a second design condition x2 such as a first operation voltage from the fabrication factory and also use the computer device to analyze and compute the global process variation of σ_{g}²(x2) under the second design condition x2 from the model data provided by the fabrication factory. Then, the value of spatial process variation actually measured under a design condition will be equal to a result of a corresponding spatial distance value multiplied by a corresponding slope value under the design condition. Thus, as mentioned in Steps S120 and S125, the circuit designer for example can use the computer device to calculate a first sloe value ss(x1) of distance-to-spatial relation under the first design condition x1 according to a spatial distance value d between a first circuit unit and a second circuit unit of the integrated circuit chip and the spatial process variation σₛ²(x1) under the first design condition x1, and can also calculate a second slope value ss(x2) of distance-to-spatial relation under the second design condition x2 according to the spatial distance value d between the first circuit unit and second circuit unit of the integrated circuit chip and the spatial process variation σₛ²(x2) under the second design condition x2. The relation among the two slope values, the spatial distance value d, and the corresponding spatial process variations can be indicated by the following equations:

$${{σ}_{s}}^{2} ( x 1 ) = ss ( x 1 ) \times d ; and$$

$${{σ}_{s}}^{2} ( x 2 ) = ss ( x 2 ) \times d .$$

Then, after calculating the first slope value ss(x1) and the second slope value ss(x2), the circuit designer for example may use the computer device to execute the above regression calculation (as shown in Step S130) to calculate a linear regression coefficient a1 and a polynomial regression coefficient b1 according to the first slope value ss(x1), the second slope value ss(x2), the global process variation σ_{g}²(x1) under the first design condition x1, and the global process variation σ_{g}²(x2) under the second design condition x2. The regression calculation can be indicated by the following equations:

$$ss ( x 1 ) = a 1 \times {( {{σ}_{g}}^{2} ( x 1 ) )}^{b 1} ; and$$

$$ss ( x 2 ) = a 1 \times {( {{σ}_{g}}^{2} ( x 2 ) )}^{b 1} .$$

In addition, as shown in Step S135, the circuit designer for example may use the computer device to simulate and calculate a global process variation σ_{g}²(x3) under a third design condition x3 which is different from the two previous design conditions, e.g. another different operation voltage. Then, after estimating the linear regression coefficient a1 and polynomial regression coefficient b1, the circuit designer for example can use the computer device to calculate slope value ss(x3) of distance-to-spatial relation under the third design condition x3 according to the linear regression coefficient a1, the polynomial regression coefficient b1, and the global process variation σ_{g}²(x3) under the third design condition x3 (Step S140). The calculated third slope value ss(x3) can be indicated by the following equation:

$$ss ( x 3 ) = a 1 \times {( {{σ}_{g}}^{2} ( x 3 ) )}^{b 1} .$$

Then, after calculating the third slope value ss(x3), the circuit designer for example can use the computer device to estimate a spatial process variation σₛ²(x3) of the spatial distance value d between the first and second circuit units under the third design condition x3 according to the calculated third slope value ss(x3) and the spatial distance value d. The spatial process variation σₛ²(x3) can be indicated by the following equation:

$${{σ}_{s}}^{2} ( x 3 ) = ss ( x 3 ) \times d .$$

Thus, the circuit designer for example can use the computer device to linearly estimate and calculate a percentage derate value corresponding to the estimated spatial process variation σₛ²(x3) according to the estimated spatial process variation σₛ²(x3), the actually measured spatial process variation σₛ²(x1), a percentage derate value corresponding to the spatial process variation σₛ²(x1), the actually measured spatial process variation σₛ²(x2), and another percentage derate value corresponding to the spatial process variation σₛ²(x2), and then the estimated percentage derate value can be employed to compensate and mitigate the cell delay of the circuit units caused by an actual spatial process variation of the spatial distance value d under the third design condition x3.

For example (but not limited), the actually measured data of a spatial variation model may merely include two different percentage derate values, e.g. 1.034 and 1.048, respectively corresponding to different spatial process variations under two different operation voltages such as 0.765 Volts and 0.675 Volts. For a new design condition such as a different operation voltage 0.585 Volts, the percentage derate value corresponding to the actually measured spatial process variation under the different operation voltage 0.585 Volts for example may be 1.0732. However, the conventional method may directly refer to and use a percentage derate value (e.g. 1.048) corresponding to a neighboring operation voltage 0.675 Volts (neighboring to 0.585 Volts) as the resultant percentage derate value corresponding to the operation voltage 0.585 Volts.; the percentage derate value 1.048 significantly varies from the actually measured percentage derate value 1.0732, e.g. the difference ratio between the two derate values is larger than 2.58. The performance of the integrate circuit chip will be affected due to this. Compared to the conventional methods, the method using regression analysis calculation provided in the embodiments can obtain a more accurate percentage derate value, e.g. 1.0734, without actually measuring data of the chip. For example (but not limited), the percentage difference between the more accurate percentage derate value 1.0734 and the actually measured percentage derate value 1.0732 is smaller than 0.5%. That is, the method in the embodiments can generate the percentage derate value having the higher accuracy as well as rapidly generate the data of a spatial variation model with the low cost advantage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An estimation method of an integrated circuit chip used in an integrated circuit design, comprising:
obtaining a global process variation under a first design condition and a spatial process variation under the first design condition;
obtaining a global process variation under a second design condition and a spatial process variation under the second design condition;
calculating a first slope value of a distance-to-spatial relation under the first design condition according to a spatial distance value between a first circuit unit of the integrated circuit chip and a second circuit unit of the integrated circuit chip and the spatial process variation under the first design condition, both the first circuit unit and the second circuit unit having a specific circuit design structure;
calculating a second slope value of a distance-to-spatial relation under the second design condition according to the spatial distance value and the spatial process variation under the second design condition;
calculating a linear regression coefficient and a polynomial regression coefficient according to the first slope value, the second slope value, the global process variation under the first design condition, and the global process variation under the second design condition;
simulating to calculate a global process variation under a third design condition;
calculating a third slope value of a distance-to-spatial relation under the third design condition according to the linear regression coefficient the polynomial regression coefficient, and the global process variation under the third design condition; and
estimating a spatial process variation of the third deign condition for the spatial distance value between the first circuit unit and the second circuit unit according to the third slope value and the spatial distance value.

2. The estimation method of claim 1, wherein the first sloe value is a result generated from the spatial process variation under the first design condition divided by the spatial distance value.

3. The estimation method of claim 1, wherein the second slope value is a result generated from the spatial process variation under the second design condition divided by the spatial distance value.

4. The estimation method of claim 1, wherein the design condition is x1, the first slope value is ss(x1), the global process variation under the first design condition is σ_{g}²(x1), the second design condition is x2, the second slope value is ss(x2), the global process variation under the second design condition is σ_{g}²(x2), and the linear regression coefficient a1 and the polynomial regression coefficient b1 is calculated from two equations in the following:
$$ss ( x 1 ) = a 1 \times {( {{σ}_{g}}^{2} ( x 1 ) )}^{b 1} ;$$
$$ss ( x 2 ) = a 1 \times {( {{σ}_{g}}^{2} ( x 2 ) )}^{b 1} .$$

5. The estimation method of claim 4, wherein the global process variation under the third design condition is σ_{g}²(x3), and the third slope value is ss(x3) is indicated by one equation in the following:
ss(x3)=a1×(σ_{g}²(x3))^{b1};
wherein the spatial process variation under the third design condition is identical to a result generated from the slope value multiplied by the spatial distance value between the first circuit unit and the second circuit unit.

6. An integrated circuit chip, comprising:
a first circuit unit; and
a second circuit unit, both the first circuit unit and the second circuit unit having a specific circuit design structure;
wherein a spatial distance value between the first circuit unit and the second circuit unit of the integrated circuit chip and a spatial process variation of a first design condition of the integrated circuit chip are used to calculate a first slope value of a distance-to-spatial relation under the first design condition; the spatial distance value and a spatial process variation of a second design condition of the integrated circuit chip are used to calculate a second slope value of a distance-to-spatial relation under the second design condition; the first slope value, the second slope value, a global process variation under the first design condition of the integrated circuit chip, and a global process variation under the second design condition of the integrated circuit chip are used to calculate a linear regression coefficient and a polynomial regression coefficient; the linear regression coefficient, the polynomial regression coefficient, and a global process variation of a third design condition of the integrated circuit chip are used to calculate a third slope value of a distance-to-spatial relation under the third design condition; and, the third slope value and the spatial distance value are used to calculate a spatial process variation under the third design condition of the integrated circuit chip under the spatial distance value between the first circuit unit and the second circuit unit.

7. The integrated circuit chip of claim 6, wherein the first slope value is a result generated from the spatial process variation under the first design condition divided by the spatial distance value.

8. The integrated circuit chip of claim 6, wherein the second slope value is a result generated from the spatial process variation under the second design condition divided by the spatial distance value.

9. The integrated circuit chip of claim 6, wherein the first design condition is x1, the first slope value is ss(x1), the global process variation under the first design condition is σ_{g}²(x1), the second design condition is x2, the second slope value is ss(x2), the global process variation under the second design condition is σ_{g}²(x2), and the linear regression coefficient a1 and the polynomial regression coefficient b1 are calculated by two equations in the following:
$$ss ( x 1 ) = a 1 \times {( {{σ}_{g}}^{2} ( x 1 ) )}^{b 1} ;$$
$$ss ( x 2 ) = a 1 \times {( {{σ}_{g}}^{2} ( x 2 ) )}^{b 1} .$$

10. The integrated circuit chip of claim 9, wherein the global process variation under the third design condition is σ_{g}²(x3), and the third slope value is ss(x3) and is indicated by a following equation:
$$ss ( x 3 ) = a 1 \times {( {{σ}_{g}}^{2} ( x 3 ) )}^{b 1} ;$$
wherein the spatial process variation under the third design condition is equal to a result generated from the third slope value multiplied by the spatial distance value between the first circuit unit and the second circuit unit.
